(19) United States
(12) Patent Application Publication
(10) Pub. No.: US 2003/0084360 A1
(43) Pub. Date: May 1, 2003

(54) Method of synchronizing and phase staggering two or more sampled data systems

(76) Inventors: David Alexander Grant, Dallas, TX (US); Thomas Lane Fowler, Garland, TX (US); Brian Gregory Rush, Southlake, TX (US)

Correspondence Address: Dan Swayze, Texas Instruments Incorporated, P.O. Box 655474, M/S 3999, Dallas, TX, 75265, US

(21) Appl. No.: 09/934,099

(22) Filed: Aug. 21, 2001

(51) Int. Cl. G06F 1/12

(52) U.S. Cl. 713/400

(57) ABSTRACT

A synchronized sampled data system comprising two or more sampled data circuits (10) each sharing a common databus (12) providing instructional words. Each sampled data system has an output (20) synchronized and phase shifted with respect to the other by preloading a unique start word into its respective internal counter (22) via a common control line. After initialization, each counter is clocked in synchronization with the other by a common clock (SCLK), such that the counter's counts remain the predetermined count difference from the other, and respective circuit output (20) maintains the corresponding phase relationship. The present invention finds particular advantages controlling switching power supplies and A to D converters. A desired phase lag can be established with a granularity of 1/M clock cycles. The present invention achieves lower input ripple current, lower in-band conducted emissions and better signal to noise ratio of the whole system.

### CROSS REFERENCE TO RELATED APPLICATIONS

Cross-reference is made to commonly assigned U. S. Patent Application Attorney's Docket Number TI-33160, filed herewith, the teachings of which are incorporated herein by reference.

### FIELD OF THE INVENTION

The present invention is generally related to sampled data systems such as power supplies having power converters and A to D converters, and more particularly to a method and apparatus for synchronizing and phase staggering the two or more sampled data systems.

### BACKGROUND OF THE INVENTION

Sampled data systems, such as switching power supplies and A to D converters, are often synchronized and phase staggered. For instance, in applications such as for use at a central office (CO) of an asymetric digital subscriber line (ADSL) system, this provides the benefit of operating power converters within the bandwidth of the served communication channel. The output signals of these sampled data systems are typically phase staggered to distribute the in-band noise power more evenly to contribute to the improved signal to noise (S/N) ratio in the communication channel.

Conventional methods require handshaking or other complex communication algorithms between the respective sampled data systems to achieve phase staggering, such as in the use of switching power converters. This methodology contributes to the complexity of both maintaining synchronization and phase staggering of the sampled data systems.

There is desired a simplified method and apparatus for establishing and maintaining both synchronization and phase staggering between sampled data systems such, as switching power supplies having power converters and A to D converters.

### SUMMARY OF THE INVENTION

The present invention achieves technical advantages as a circuit and methodology whereby two or more sampled data systems utilize one instructional word from a shared databus to both establish and maintain synchronization, as well as a predetermined phase staggering with respect to each other.

The present invention utilizes at least one designated pin per sampled data system which is utilized as a system identifier. Each sampled data system, such as a power supply, recognizes a high state or low state of at least one dedicated pin to uniquely identify the sampled data system. A synchronization command on a shared serial databus causes each sampled data system to load a predetermined start word into a respective internal counter as a function of the dedicated pinstate. This loaded word establishes a predetermined phase difference, such as 180°, which is dependent on the high state or low state of the dedicated identifier pin. Each sampled data system then commences to count common system clock cycles, and performs conversions out of phase with one another, accurately an continuously thereafter.

The present invention is extendable to systems that have more than two sampled data systems. Using N identifier or control lines, the present invention can phase stagger ₂N sampled data systems using one instructional word on a shared databus. The phase staggering can have any desired phase resolution with 1/M clock cycles and does not need to be restricted to multiples of two.

By using additional identifier pins, the number of clock signals in a count period can be uniquely attributed to a sampled data system. This allows two sampled data systems operating at different specified frequencies and designated phase differences.

Only one instructional word is needed to synchronize the sampled data systems. Moreover, the sampled data systems do not need to be unique. The invention applies to any desired phase lag with a granularity of 1/M clock cycles, with M being defined as the number of clock signals in a count interval, even or odd. The present invention is further extendable to establish and refresh difference frequencies between the sampled data systems with a known phase at a common initialization instant.

The present invention achieves technical advantages since only one instructional word is used to accomplish the synchronization and phasing of multiple systems. Lower input ripple current is established, as well as lower in-band conducted emissions which results in better signal to noise ratio of the host system.

### BRIEF DESCRIPTION OF THE DRAWINGS

For a more complete understanding of the present invention, reference is made to the following detailed description taken in conjunction with the accompanying drawings wherein:

FIG. 1 is a functional block diagram of a sampled data system comprising a switching power supply having a power converter;

FIG. 2 is an 8 channel application circuit schematic depicting two power supplies of FIG. 1 each having a respective control pin connecting to and sharing a common instructional signal line, each power supply having a plurality of output lines adapted to be phase staggered and synchronized with respect to the other output lines by utilizing a common control word;

FIG. 3 is a serial control interface timing diagram associated with each of the power supplies;

FIG. 4 is a block diagram of an eight channel AC5 line card utilized in an ADSL application at a central office; and

FIG. 5 is waveform timing diagram illustrating a control word begin loaded into each of the power supplies during initialization, such that after initialization the output to the respective devices are both phase staggered and synchronized with respect to one another as the system is clocked thereafter.

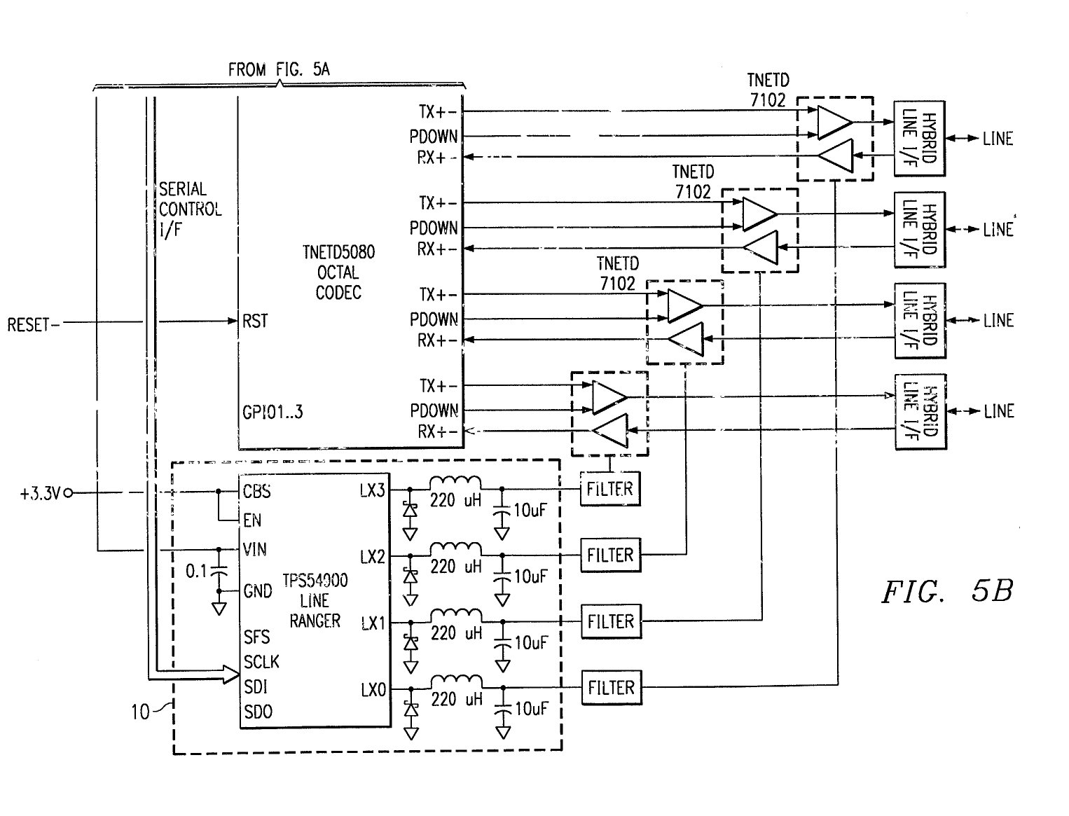

### DETAILED DESCRIPTION OF THE PREFERRED EMBODIMENT

For purposes of understanding and clarity, the method and apparatus of the present invention will now be discussed in considerable detail with specific reference to the synchronization and phase staggering of two or more switching power supplies having respective power converters. It is set forth that the illustration of synchronizing and phase staggering of power supplies is one representative embodiment of synchronized and phase staggered sampled data systems, with it being understood that the present invention applies to the synchronization and phase staggering of other sampled data systems such as A to D converters which can use one instructional word from a shared databus, as will now be described in detail.

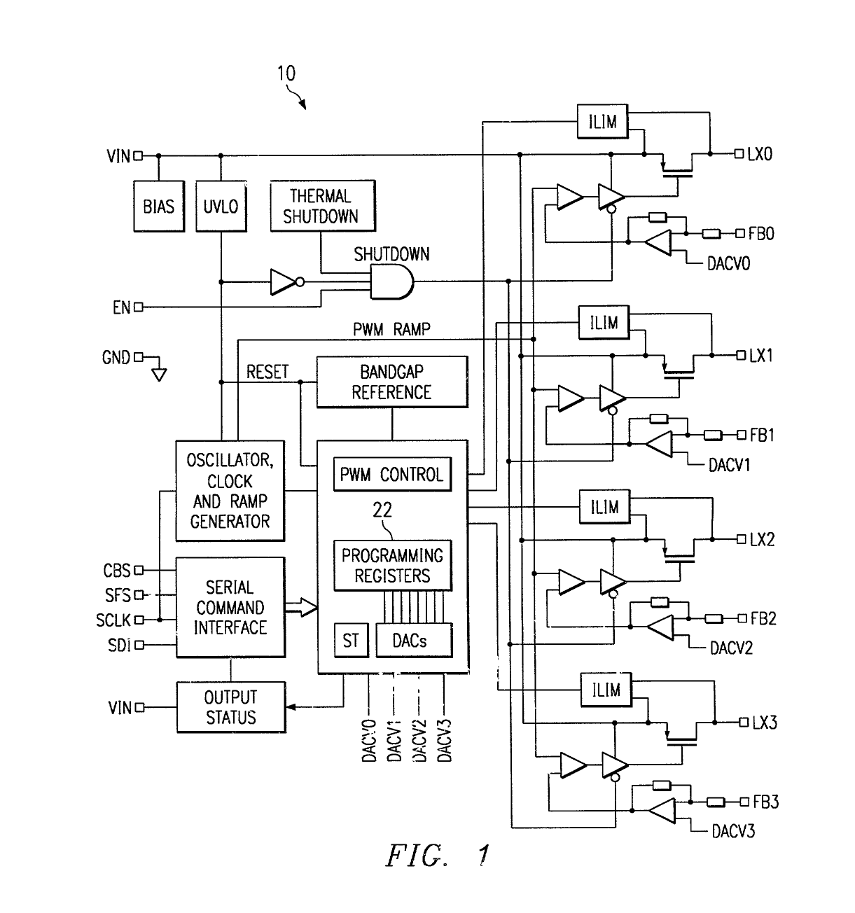

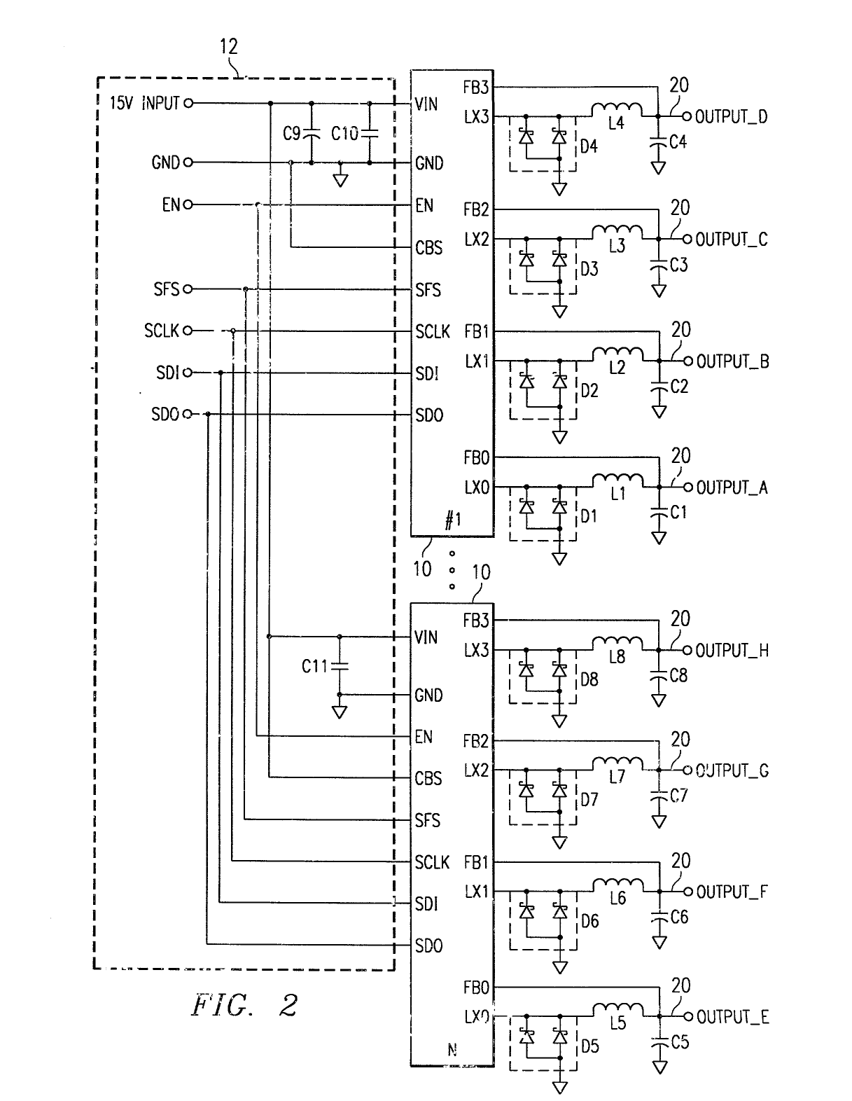

Referring to FIG. 1, there is illustrated at 10 a functional block diagram of one switching power supply having various interconnected control functions. These various functions will be described in considerable detail shortly, with a particular detailed description of the integration of two or more of these switching power supplies now being discussed, in reference to FIG. 2.

Referring to FIG. 2, there is illustrated two switching power supplies 10, each controllably coupled to a common shared serial databus generally shown at 12. While two switching power supplies 10 are illustrated, it is to be recognized that N devices could be coupled to the common shared databus 12, wherein each device 10 has a respective control input being designated as control pin CBS, N being an integer number of two or greater and being equal to 2 in this discussion. As shown in FIG. 2, the first or upper power supply 10 has its CBS control line tied to ground, and the second or lower power supply 10 having its respective CBS pin connected to VCC, being 15 volts in this illustration. This CBS pin is dedicated as an identifier such that each power supply 10 recognizes the high state or low state assigned to the dedicated pin which uniquely identifies the power supply when receiving a command instructional word.

The present invention facilitates both the synchronization and phase staggering of the respective outputs, seen in this case to be four output lines 20.

The multiple power supplies 10 share the common serial databus 12, and are each adapted to be preloaded by a synchronization command word routed via the shared serial databus 12 to cause each power supply 10 to load a different predetermined start word into its internal counter. This loaded start word establishes a count establishing an output having a predetermined phase difference, such as 180° phase difference, with respect to the other output that is dependent on the high state or low state of the dedicated identifier CBS pin. Each counter of the respective system 10 then commences to count system clock cycles from clock line SCLK maintaining an output that is 180° out-of-phase with the other.

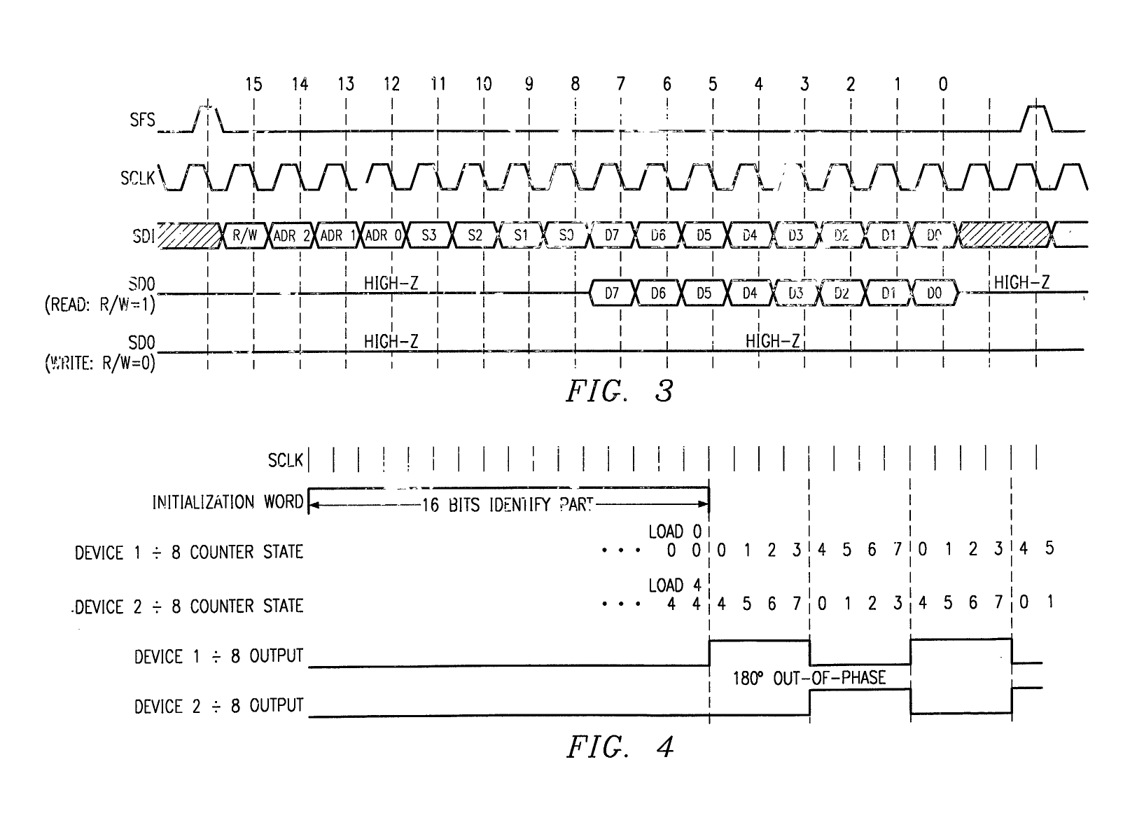

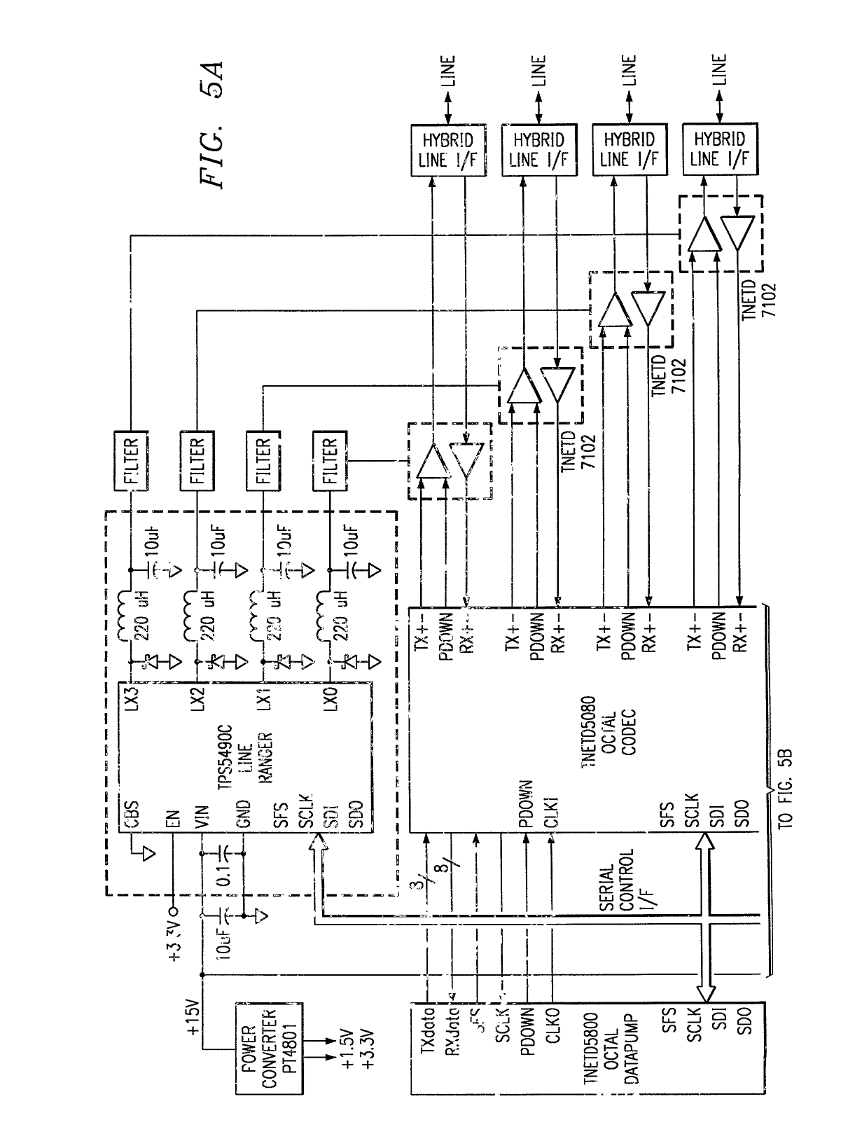

FIG. 3 depicts the serial control interface timing diagram for each power supply 10 that will be discussed in more detail shortly. The present invention can be further understood in reference to FIG. 4 whereby it is depicted that the counter of the first power supply 10 is preloaded with a count “0” during the initialization command word, while the second device 10 is preloaded with a count “4”. For this example there are eight counts (clock signals) for each period. If, for instance, it is desired to provide outputs that are 90° out of phase with one another, the second device 10, for instance, can be preloaded with either a count of 2 or 6, depending on which device is intended to be 90° leading the other.

Advantageously, FIG. 4 depicts that the output signals from the respective devices 10 are 180° out of phase with respect to the other in this embodiment. After initialization, the counters of each device 10 continue to count in synchronization with the clocks provided on line SCLK, with the counts of the respective counters each remaining a count difference of 4. Since each counter is clocked by the same common clock signal, they will always maintain this count difference, and thus the outputs of the respective devices 10 will maintain the same phase difference while maintaining synchronicity.

The present invention can be extended to systems that have more than two sampled data systems, i.e., to more than two power converters, D to A converters etc. By using “N” identifier pins, whereby N equals two or more, this invention can phase stagger up to 2^{N} power supplies 10, A to D converters, or other data sampling systems using one instructional word on a shared serial databus. Phase staggering can have any desired phase resolution within M clock signals, and does not necessarily need to be restricted to multiples of 2.

Further, by using additional identifier pins for each part, i.e. two or more identifier pins for each part, the number of cycles in a count period can be uniquely attributed to a device. This extension of the invention results in the 2 sampled data systems operating at different, specified frequencies and designated phase differences.

Only one instruction word is needed to synchronize the power converters 10. The present invention utilized identifier pins on the converters such that the converters do not need to be unique parts. The present invention can be applied to any desired phase lag with granularity defined as 1/M clock cycles, with M being the number of clock cycles in a particular count interval, even or odd. In this embodiment, it is illustrated where there are eight clock cycles in a count interval, thus M=8. However, there could be a different number of predetermined clock cycles per count interval, such as M being equal to 16 if it desired to double the granularity of the system.

The present invention can be further extended to establish and refresh different frequencies between the converters 10 with a known phase at a common initialization instant.

The present invention achieves technical advantages by utilizing and requiring only one instructional word to accomplish both synchronization and phase shifting. The present invention achieves lower input ripple since the outputs are 180° out of phase and tend to cancel one another. Further, by delaying the phase between the two power converters 10, noise generated at the switching instants occurs at twice the repetition rate and is half the current of conventional unstaggered synchronized converters. Thus, the present invention provides a benefit of lower in-band conducted emissions which results in a better signal to noise ratio of the host system. For instance, this provides a benefit in a central office ADSL application because the converters operate within the band of the communications channel. The phase staggering distributes the in-band noise power more evenly, which, again, contributes to improve signal to noise ratio in the communication channel.

The present invention does not require hand-shaking or other complex communications between the phase staggered converters. Rather, a dedicated pin per device is utilized as an identifier such that the device 10 can recognize the high or low state of the dedicated pin and uniquely identify the device. The common synchronization word provided to each device on the shared serial databus causes each device to load a predetermined start word into its internal counter, which implementation is an architecturally superior implementation. For instance, if 4, 6, 8, or other numbers of sampled data systems 10 are to be synchronized and phase staggered with respect to one another, the respective number of identifier pins or pin state combination would be provided for each device, whereby each device would be preloaded with a respective count corresponding to the desired phase shift with respect to the other device. For instance, if 4 power supplies are to be synchronized and phase staggered, a first device could be preloaded with a count 0, the second device pre-loaded with a count 2, the third device preloaded with a count 4, and the fourth device preloaded with a count 6, all as a function of one common command word. This would provide that each device in an 8 clock cycle count interval would be 90° with respect to the other.

As a further illustration of the present invention, if two devices are to be synchronized, with one operating at twice the operating frequency as the other, the second device would have additional identifier pins, such that the number of clock cycles in a count period can be uniquely attributed to the respective converter.

Referring now back to FIG. 1, there is shown at 10 a four channel, voltage mode step-down converter incorporating the present invention, providing four independently controllable output voltages. Each regulated channel includes a high-side PMOSFET switch with a typical R_{Ds} (ON) of one ohm, which makes it suitable for high efficiency, low current applications. Commands sent to the converter 10 over the four wire serial port program the outputs independently or globally to supply voltages from 7.5 Volts to 13.1 Volts in 0.4 V increments. When the input voltage is desired at an output, a bypass mode can be activated which fully enhances the PMOSFET switch and disables the switching circuitry of the selected channel.

The converter 10 is an ideal companion device to power Texas Instruments THS7102 ADSL line drivers as a part of the AC5 Central Office ADSL chipset. With the AC5 chipset controlling the converter 10 output voltages, significant power savings are realized by reducing the excess supply headroom on a per line basis.

Pin Assignments

Pin assignments of a 16 pin package are defined in Table 1 below.

TABLE 1
PIN

| NAME | NO. | PIN DESCRIPTION | FUNCTIONAL |
|---|---|---|---|
| | | DESCRIPTION | |
| LX0 | 1 | Channel 0 switch output | Output to |
| | | | inductor and catch diode |
| LX1 | 2 | Channel 1 switch output | |
| GND | 3 | Ground | Power and Analog Ground |
| SFS | 4 | Frame sync input | Read/Write frame |
| | | | start strobe |
| SDI | 5 | Serial data in | 8 bit address/16-bit |
| | | | data word signal |
| EN | 6 | Enable | EN < Vᵢₗ: Disable |
| | | | :all channels, |
| | | | EN > Vᵢₕ:Enable activates |
| | | | outputs (see text) |
| FB0 | 7 | Channel 0 feedback input | Feedback from L-C |
| | | | filter output |
| FB1 | 8 | Channel 1 feedback input | |
| FB2 | 9 | Channel 2 feedback input | |
| FB3 | 10 | Channel 3 feedback input | |
| CBS | 11 | Channel bank select | Assigns internal channels |
| | | | to respond to serial |
| | | | address bit ADR2= 0 when |
| | | | CBS < Vᵢₗ, or to |
| | | | ADR2 = 1 when CBS > Vᵢₕ |
| SCLK | 12 | Serial clock input | Serial clock/ |
| | | | synchronization signal |
| SDO | 13 | Serial data out | Status data output signal |
| VIN | 14 | Input supply voltage | Chip supply and |
| | | | channel 0-3 switch input |
| LX2 | 15 | Channel 2 switch output | Output to inductor |
| | | | and catch diode |
| LX3 | 16 | Channel 3 switch output | |

With continued reference to FIG. 1, various functional blocks will now be discussed.

Reference System/Voltage Divider & Multiplexer

The reference system consists of a band-gap circuit, four digital to analog converter outputs (DACs), and smoothing filters. The reference system provides independent set-point voltages to the PWM control loops of each channel, and are programmed via the 4 wire serial port. Output control of the regulators is provided in 15 steps with 400-millivolt resolution over a range of 7.5 V to 13.1 V. The DACs can also be programmed to force the PMOSFETs into the fully “on” pass-through or bypass mode to pass the input voltage to any output.

UVLO Circuit & Power-Up State

The Under-Voltage Lockout (UVLO) circuit controls device operation when the input voltage is below the UVLO threshold such as during power-up or power-down. Hysteresis built in to the UVLO detection circuit reduces sensitivity to noise and ripple on the power supply inputs to the converter 10. Prior to reaching the UVLO threshold, the ramp oscillator is disabled so that no switching occurs in the converter 10, the PMOS transistors are forced into the off state, and the registers and DACs are reset. Once the UVLO threshold is reached, the soft-start sequence begins. If the input voltage falls below the UVLO threshold after the device is programmed and operating, all four outputs are disabled, the DACs are set to zero volts and the programming registers are reset. Subsequently returning VIN above the UVLO threshold will require re-initialization of the phase stagger and channel voltage programming.

Soft-Start Sequence and Voltage Transitioning

When the supply voltage exceeds the UVLO threshold, the converter 10 is ready to be programmed via the serial interface. As each channel is programmed and enabled with a voltage code, the channel DACs begin stepping the output up from zero volts to the target voltage in 200-millivolt increments. If the target voltage is 15 Volts (i.e.pass-through mode) the DAC will continue to increment in 200-millivolt steps between 13.1 Volts and the fully “on” state. When a channel is commanded to transition from one voltage level to another, the output steps up (or down) to the new level in 200-millivolt increments. The period between each DAC increment is approximately 250 microseconds when the SCLK frequency equals 4.416 MHz. This results in a maximum ramp-up time of 8 milliseconds when stepping from OV to 15 V, and a maximum transition time between max and min regulation voltages (7.5 V, 13.1 V) of 4 milliseconds. The use of small stop increments provides a smooth predictable ramp and prevents inadvertent tripping of the overcurrent limit.

Note that while an output is transitioning to the new target voltage, its voltage code register is protected from being overwritten. During this transition period, the channel status may be read via the 4 wire serial port using the read protocol. The data returned will be non-zero while channel is transitioning.

Oscillator, Divider & Sync Circuit

The converter 10 has a free-running internal ramp oscillator that operates at a nominal frequency of 450 kHz. When the 4.416 MHz SCLK signal is present, a synchronous divide-by-eight circuit provides a 552 kHz clock to synchronize the PWM ramp. The start of the ramp is coincident with every eighth rising edge of SCLK. If the converter 10 SCLK pin is driven at a frequency lower than eight times the free-running frequency of the oscillator (f_{osc}), it may result in chaotic operation. Care should be taken to guarantee that the minimum frequency at the SCLK input is 4.0 Megahertz.

Phase Stagger Circuit

When two converter circuits 10 are used as a pair to operate as an 8-channel unit, the PWM ramps in the two devices can be advantageously phase staggered to reduce input ripple and bypass requirements as previously discussed in detail earlier. The initialization command forces the PWM ramp of the converter 10 with its CBS pin tied low to be staggered by four SCLK cycles compared to the device with its CBS pin forced to a logic high. Note that this command clears the voltage programming in both converters 10 and disables the outputs. Voltage programming instructions can be issued immediately following the initialization command.

Enable (EN)

If the EN pin is held low when the converter 10 is powered up, the oscillator will start and free-run. Serial commands to initialize the PWM clocks and program the output levels will be accepted, but the outputs will be held off and will not begin regulating until the EN pin is pulled above Vᵢₕ.

If the converter 10 is programmed with outputs enabled when EN is pulled LOW, all outputs are shut off and all DACs are reset. The EN pin does not affect the oscillator, which continues to run and maintain PWM phase stagger. The previously programmed channel voltages are also maintained in the registers. If EN is pulled above Vᵢₕ, the converter 10 channels start up through the soft-start sequence and reach regulation at the previously programmed target voltages.

Bypass mode may be forced on all outputs by pulling EN above VIN−0.2 V. When bypass mode is forced, all four channels step up to 15 V in 200-millivolt increments.

Over Current Protection

During steady state operation, the overcurrent protection threshold is 150 milliamps minimum, 300 milliamps maximum, sampled approximately 500 nanoseconds after the start of the switching cycle. When overcurrent is sensed in the PMOSFET, the output is disabled for a “hiccup” time of 170 to 360 milliseconds (SCLK=4.416 MHz). In the “pass-through” mode, the overcurrent detection remains active and the “hiccup” behavior is unchanged.

During the soft-start sequence and voltage transitioning, the currents in the PMOSFET are higher than steady state. The overcurrent trip threshold is increased to prevent inadvertent shut-down & re-start action (hiccupping) in the overcurrent protection circuit.

Thermal Shutdown

Thermal shutdown disables the controller if the junction temperature exceeds 150° C. The hysteresis is 10° C. This shuts down off the switching circuitry and resets the soft-start circuitry. If the IC returns to normal temperature, it re-starts and returns to the programmed target voltages.

Serial Control Interface Timing Diagram

The serial control interface timing is depicted in FIG. 3.

Serial Command Bit Assignments

The serial command bit assignments are depicted in Table 2 below.

TABLE 2
SERIAL BIT

| POSITION | NAME | DESCRIPTION |
|---|---|---|
| 15 | R/W* | Set to logic 1 to read from converter, |
| | | set to logic 0 to write to converter |
| 14 | ADR2 | Channel bank select, compared to logic state |
| | | of CBS pin to select between two converter |
| | | devices used in an 8 channel configuration |
| 13 | ADR1 | Internal channel select MSB, used with ADR0 |
| | | to select one of four output channels |
| 12 | ADRO | Internal channel select LSB, used with |
| | | ADR1 to select one of four output channels |
| 11 | S3 | Device address MSB (S3=1 required to |
| | | address converter) |
| 10 | S2 | Device address bit (S2=1 required to |
| | | address converter) |
| 9 | S1 | Device address bit (S1=1 required to |
| | | address converter) |
| 8 | S0 | Device address LSB (S0=1 required to |
| | | address converter) |
| 7 | D7 | Voltage programming MSB |
| 6 | D6 | Voltage programming bit |
| 5 | D5 | Voltage programming bit |
| 4 | D4 | Voltage programming LSB |
| 3 | D3 | Channel enable/disable (D3=0 enables |
| | | channel(s)) |
| 2 | D2 | Global start |
| 1 | D1 | Unassigned |
| 0 | DO | Initialize counters |

Valid Commands

Valid commands to the converter are shown in Table 3 below.

TABLE 3

| WORD | DESCRIPTION |
|---|---|
| 0000111100001001 | Initialize PWM clocks with phase stagger |
| | and disable all channels |
| Oddd1111vvvv0100 | Turn on & regulate all channels to voltage |
| | code vvvv (see voltage programming code table) |
| Oaaa1111vvv0000 | Turn on & regulate channel aaa to voltage code |
| | vvvv (see voltage programming code table) |
| Oaaa1111dddd1000 | Disable channel aaa |
| 1aaa1111dddddddd | Read channel status from channel aaa |

Voltage Programming Codes

Voltage programming codes are shown by Table 4 below.

TABLE 4

| VOLTAGE CODE | OUTPUT | VOLTAGE CODE | OUTPUT |
|---|---|---|---|
| (D4-D7) | VOLTAGE | (D4-D7) | VOLTAGE |
| 0 | 7.5 | 8 | 10.7 |
| 1 | 7.9 | 9 | 11.1 |
| 2 | 8.3 | A | 11.5 |
| 3 | 8.7 | B | 11.9 |
| 4 | 9.1 | C | 12.3 |
| 5 | 9.5 | D | 12.7 |
| 6 | 9.9 | E | 13.1 |
| 7 | 10.3 | F | Pass through |
| | | | mode |

Channel Status Read Back Codes

Channel status read back codes are shown in Table 5 below.

TABLE 5

| STATUS BYTE VALUE | OUTPUT MEANING |
|---|---|
| (D0-D7) | |
| 00h | Channel settled to regulation window |
| FFh | Channel not settled or fault condition (note 1) |

Note 1: Fault conditions detected include over current fault on channel addressed and over temperature fault for device (all channels)

Serial Interface Protocol

According to the present invention, the serial interface uses SCLK (Serial Clock), SFS (Serial Frame Sync), SDI (Serial Data In) and Bank Select inputs, and outputs device status on SDO (Serial Data Out). SFS and SDI inputs are sampled on the falling edge of SCLK. An SFS pulse indicates that the bus master is ready to transmit a word, and the bit and frame counters in the converter 10 are reset when SFS is high. The first bit (b15) of the 16-bit word is shifted in on the next failing edge of SCLK. The first eight bits of the word are denoted as the Address or Command, and the last eight bits are Data. Refer to the table titled “Serial Command Bit Assignments”.

The Command consists of three fields—the R/W bit; Channel Select bits ADR2-0; and four Device Select bits S3-SO. The R/W bit determines whether the data portion of the word will be written to the converter 10 or read from the converter 10. The value in the Channel Select field determines which output channel is to receive programming data. Channel select bit ADR2 is compared to the logic level on the Channel Bank Select input. This allows two distinct converter 10 devices to be addressed as one logical eight-channel unit. The remaining bits ADR1, ADR0 are decoded to select one of the four on chip channels. The third part of the command is the 4-bit Device Select, bits S3-SO. The converter 10 has been assigned a device ID of “F” for S3-SO. This value must be used to address converter devices.

The data field, D7-D0, is used to program output voltage levels and control the converter operation.

Pass through Mode

The pass through mode may be used to force a channel's PMOSFETs to remain in the fully enhanced “on” state. Use of the pass through mode is desirable under several conditions. First, transmitting high peak-to-peak voltages will require maximum headroom on the line driver supply. Second, if the load current is too small, the Line Ranger circuit will be required to operate in discontinuous mode. The output may ring in response to transient conditions. Low load current conditions may occur if the line driver is idle and the quiescent current has been reduced to conserve power. If the line must remain ready to return to normal operation, the pass through mode is appropriate. If the line is unused or can tolerate start up delays, the channel shut down mode should be considered to conserve additional power.

Channel Shut Down

A bit value of 1″ in bit 3 is used to shut down the addressed channel. Shutting down of an unused channel is recommended when power savings warrant complete power down of a line Ad~r driver, and start up delays in returning to normal operation are not critical.

Global Program

Data Bit 2 in the serial word is the “global turn-on and regulate” signal. It is used to program all outputs to the same voltage and start them up at the same time.

PWM Clock Initialization

Data Bit 0 is used to initialize the on-board clocks. The signal to initialize the clocks is ANDed with data bit 5 and cannot be given without powering down the converter 10 and going through a complete restart sequence.

Status Readback

The converter 10 is designed to monitor its output state and recognize when it has settled into regulation at its programmed value according to the present invention as previously described in detail. The SDO pin, reports a channel in a voltage transition or error condition (Channel Not Ready) by returning a data value of FFh. When SDO returns a value of 00h, the channel is in regulation.

The following conditions will cause a “Channel Not Ready” status to be reported:

Channel Disabled

PWM duty factor outside expected range (i.e. 0% or 100% PW)

Channel in overcurrent

Channel Transitioning to New Target Value

Over-temperature Shutdown (affects all four channels)

Noise immunity circuits in the fault detector introduce a delay in the reporting of the channel status. For instance, if a command to transition to a new target voltage is issued, the output voltage may be stable up to 250 microseconds before the detection circuit reports that the channel is ready. The minimum recommended status polling interval per channel is 500 microseconds.

Recommended Component Values

Table 7 depicts recommended component values for use of converter 10.

TABLE 7

| Ref. | | | | | |
|---|---|---|---|---|---|
| Designator | Device | MFR #1 | P/N | MFR #2 | P/N |
| C1-5 | 10 uF Tantalum Cap | Kemet | T495D106 | | |
| | | | M035AS | | |
| C6 | 0.1 uF Ceramic Cap | Kemet | | AVX | |
| L1-4 | 220 uH Inductor GCI | 5143 | JW Miller | PM74S- | |
| | | | | | 221K |
| D1-4 | Schottky Diode | Diodes, Inc. | BAT54AW | | |

FIG. 2 depicts a block diagram of an eight channel AC5 line card with a Texas Instruments Line Ranger option and utilizing the power converter 10 of the present invention.

The numerous innovative teachings of the present application will be described with particular reference to the presently preferred exemplary embodiments. However, it should be understood that this class of embodiments provides only a few examples of the many advantageous uses and innovative teachings herein. In general, statements made in the specification of the present application do not necessarily delimit any of the various claimed inventions. Moreover, some statements may apply to some inventive features, but not to others.

Although a preferred embodiment of the apparatus and system of the present invention has been illustrated in the accompanied drawings and described in the foregoing Detailed Description, it is understood that the invention is not limited to the embodiments disclosed, but is capable of numerous rearrangements, modifications, and substitutions without departing from the spirit of the invention as set forth and defined by the following claims.

What is claimed is:

1. A synchronized sampled data system, comprising:
a shared data bus providing an instructional word; and
a first sampled data circuit and a second sampled data circuit each receiving the instructional word on the shared data bus, each said first circuit and said second circuit having an output phase shifted from the other as a function of at least one control signal provided to each said circuit via said shared data bus.

2. The system as specified in claim 1 wherein each said first circuit and said second circuit have a respective counter, each said counter having a different count as a function of a common said control signal.

3. The system as specified in claim 1 wherein a different predetermined start count is preloaded into each of the first circuit and the second circuit upon an in initialization of the sampled data system.

4. The system as specified in claim 2 wherein each of the first circuit and second circuit are clocked by a common clock signal to produce the phase shifted outputs, the phase shift of the outputs being correlated to the difference in counts between the respective counter.

5. The system as specified in claim 1 wherein the outputs of the first and second circuits are shifted 180° from each other.

6. The system as specified in claim 4 wherein the circuit outputs continuously maintain the phase shift when a continuously clocked by the clock signal.

7. The system as specified in claim 1 wherein each said first and second circuit comprise a power converter.

8. The system as specified in claim 7 wherein the outputs of the first and second circuits are shifted 180° from each other.

9. The system as specified in claim 8 wherein noise generated by each said power converter is staggered.

10. The system as specified in claim 9 wherein noise generated at switching instants of each said power converter occurs at twice the repetition rate and less current as compared to unstaggered synchronized power converters.

11. The system as specified in claim 7 wherein each said power converter has multiple outputs each being phase shifted with respect to the outputs of the other power converter.

12. The system as specified in claim 7 wherein each said power converter includes an integrator circuit having a value corresponding to a phase of the respective circuit.

13. The system as specified in claim 1 wherein each said first and second circuit have a plurality N of common control signals.

14. The system as specified in claim 13 wherein a selection of available shifts of the first and second circuit is 2^{N}.

15. The system as specified in claim 13 further comprising a total of 2^{N} sampled data circuits, where N is 2 or greater.

16. The system as specified in claim 4 wherein the phase shift between the first and second circuit has a granularity of 1/M clock cycles, where M is the number of clock cycles in a count interval.

17. The system as specified in claim 1 wherein each said first and second circuit comprises an A to D converter.

18. A method of phase shifting two or more sampled data circuits sharing a common databus, comprising the steps of:
operating a first and second sampled data circuit to have a phase shift from one another being a function of at least one control signal provided to each via the common databus.

19. The method as described in claim 18 further comprising the step of loading a different count into a counter of each said first and a second sampled data via the common databus.

20. The method as described in claim 19 wherein the control signal is provided on at least one common signal line to each of the first and second circuits.

21. The method as described in claim 20 further comprising N common signal lines, wherein a selection of available phase shifts between the first and second circuit is 2^{N}.

22. The method as described in claim 19 wherein each of the first and second circuits have a counter clocked by a common clock signal, wherein the phase shift between the first and second circuit has a granularity of 1/M clock cycles, where M is the number of clock cycles in a count interval.

23. The method as described in claim 18 wherein a different predetermined start count is preloaded into a counter of each of the first circuit and the second circuit upon initialization of the sampled data system.

24. The method as described in claim 19 wherein the counters of each of the first and second data circuits are clocked by a common clock signal to produce the phase shifted outputs, the phase shift of the outputs being correlated to the difference in counts of the respective counter.

25. The method as described in claim 18 further comprising a total of 2^{N} sampled data circuits, where N is 2 or greater.

26. The method as described in claim 25 wherein the outputs of each said sampled data circuit continuously maintain a predetermed phase shift upon a continuous clock of a clock signal.

27. The method as described in claim 18 wherein each said first and second circuit comprise a power converter.

28. The method as described in claim 27 wherein the outputs of the first and second circuits are shifted 180° from each other.

29. The method as described in claim 27 wherein noise generated by each power converter is staggered.

30. The method as described in claim 29 wherein noise generated by thepower converters at switching instants occurs at twice the repetition rate and half the current as compared to unstaggered synchronized power converters.

31. The method as described in claim 27 wherein each said power converter has multiple outputs each being phase shifted with respect to the outputs of the other power converter.

32. The method as described in claim 27 wherein each said power converter includes a ramp circuit having a value corresponding to a phase of the respective circuit.

33. The method as described in claim 18 wherein each first and second circuit have a plurality N of common control signals.

34. The method as specified in claim 18 wherein each said first and second circuit comprises an A to D converter.
